(19) United States
(12) Patent Application Publication
(10) Pub. No.: US 2011/0126254 A1
(43) Pub. Date: May 26, 2011

(54) METHOD AND SYSTEM FOR VIDEO DISTRIBUTION AND MANAGEMENT

(76) Inventors: Milan Polasek, Bratislava (SK); Roman Ferko, Bratislava (SK); Peter Leitner, Nové Mesto nad Váhom (SK)

(21) Appl. No.: 12/625,679

(22) Filed: Nov. 25, 2009

(51) Int. Cl. H04N 7/173; H04N 7/18; G06F 3/01

(52) U.S. Cl. 725/116; 348/143; 715/760

(57) ABSTRACT

The disclosure provides a video management and distribution system. The system includes management center, end points, and client accounts. A management center having a backend server provides a video management and distribution interface for clients. The management center backend server stores end point and client data. Clients may upload videos, view videos, create campaigns for distribution on remote points, and view statistics. Further, clients may create campaigns based at least on location, duration of campaign, dates of campaign, number of video spots in campaign, product, cost, etc. Statistics generated by management center enables clients to quickly determine video distribution decisions. End points include a display, a network connection device, and a computer-readable medium encoded with management center end point software (MCES). End points may further include a camera enabling clients to view the end point location. In one embodiment, the present disclosure enables enhanced local, regional, or continental advertising.

### FIELD

The present disclosure relates to digital video broadcast. More specifically, the present disclosure relates to video distribution and management.

### BACKGROUND

Large media outlets have long dominated video broadcast. High start-up costs and limited access to government-regulated bandwidth have been detrimental to the ability of small companies and ordinary citizens to distribute advertisements and videos across large networks. This access may provide enhanced advertising capabilities as well as increased opportunities for business owners and consumers.

In recent years, websites like YouTube™ have brought video distribution to end users, reducing the ability of large media outlets to restrict access to media. However, often times the video distribution and management systems of these sites have serious disadvantages. For example, currently no method exists to make sure uploaded content meets ethical standards across countries. Next, these sites provide no way to determine how many viewers your video may potentially reach. No current method exists for accessing a particular target audience. All of these disadvantages may seriously affect the ability of small and large businesses to determine the effectiveness of advertising campaigns.

Further, current video distribution systems typically do not provide a system for maintaining control over end distribution points. In effect, the systems do not provide a method for knowing that the video will actually be viewed by anyone. They also do not provide knowledge of where the videos will be distributed or how many times they will be played.

### SUMMARY

Therefore a need has arisen for a video distribution and management system providing access to small businesses or clients and capable of ensuring knowledge of distribution.

A further need exists for a centrally managed system that allows clients to view end distribution point locations and costs. Such a system should also ensure that clients may choose end points based on targeted advertising criteria, costs, location, and duration of video distribution.

In accordance with the disclosed subject matter a video distribution system and method is provided that substantially reduces or eliminates disadvantages and problems associated with previously developed video distribution platforms.

The present disclosure provides a video management and distribution system. The system includes at least a management center, end points, and a number of client accounts. A management center having a backend server provides a video management and distribution interface for clients. The management center backend server stores end point and client data.

Clients may upload videos, view videos, create campaigns for distribution on remote points, and view statistics. Further, clients may create campaigns based at least on location, duration of campaign, dates of campaign, number of video spots in campaign, product, cost, or other criteria. Statistics generated by the management center enable clients to quickly determine video distribution decisions. In one embodiment, clients may access the management center through a web page interface using a standard web browser.

End points include a display, a network connection device, and a computer-readable medium encoded with management center end point software (MCES). End points may further include a camera, enabling clients to view the end point location. In one embodiment, the present disclosure enables enhanced local, regional, or continental advertising.

These and other advantages of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description.

### BRIEF DESCRIPTION OF THE DRAWINGS

For a more complete understanding of the disclosed subject matter and advantages thereof, reference is now made to the following description taken in conjunction with the accompanying drawings wherein:

FIG. 1 presents one exemplary network of the present disclosure;

FIGS. 2a & 2b show examples of end point screen subdivisions;

FIGS. 3a & 3b show examples of end point screen subdivisions; and

FIGS. 4 through 20 provide screen displays associated with the operation of the presently disclosed method and system.

### DETAILED DESCRIPTION OF THE EMBODIMENTS

The detailed description set forth below in connection with the appended drawings is intended as a description of exemplary embodiments in which presently disclosed subject matter can be practiced. The term “exemplary” used through this description means “serving as an example, instance, or illustration,” and should not necessarily be construed as preferred or advantageous over other embodiments. The detailed description includes specific details for the purpose of providing a thorough understanding of the present teaching. However, it will be apparent to those skilled in the art that the presently disclosed subject matter may be practiced without these specific details.

Illustrative embodiments of this disclosed subject matter are described herein, including the best mode known to the inventors for carrying out the disclosed subject matter. Variations of those embodiments may become apparent to those of ordinary skill in the art upon reading the description. The inventor expects skilled artisans to employ such variations as appropriate, and the inventor intends for the disclosed subject matter to be practiced otherwise than as specifically described herein. Moreover, any combination of the below-described elements in all possible variations thereof is encompassed by the disclosed subject matter unless otherwise indicated herein or otherwise clearly contradicted by context.

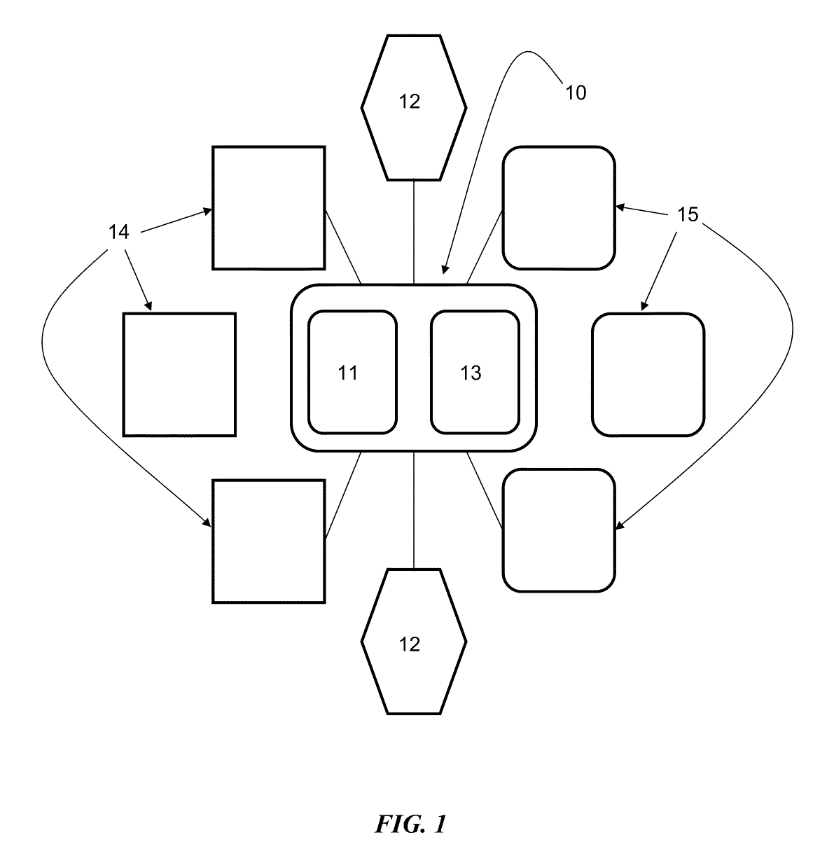

The present disclosure presents a method and system for video distribution and management. FIG. 1 shows an exemplary network of the present disclosure. Management center 10 processes uploaded videos from clients 12. Management center 10 then distributes uploaded videos to end points based on client criteria. End points may include indoor end points 14 and outdoor end points 15.

Although the specific network of FIG. 1 has been described herein, other networks known to those with ordinary skill in the art wherein the teachings of the present disclosure are applicable may also be used. For example, management center 10 may first process uploaded videos and then distribute them to a plurality of local management centers (not shown), from which videos may be disseminated to end points on their networks. All networks capable of transferring information from management center 10 or a local management center to other elements of the present disclosure will be referred to herein as a “network”. For example, networks such as WAN, LAN, local WiFi, and/or Bluetooth may all be used to distribute information to elements in the present disclosure.

Management center 10 includes a time management system for allocating resources to uploaded videos. One uploaded video will be referred to herein as a “video spot”. An uploaded video spot may include video, static or relatively static content, flash animation, or other content. A group of video spots bundled for display on one end point will be referred to herein as a “video cycle”. Management center 10 groups a series of video spots into a video cycle based on the desired time-length of the video cycle, the desired number of video spots in a video cycle, or other client criteria. In one embodiment, the number of video spots in a video cycle varies between five and thirty. After an end point displays one video cycle, the next video cycle may begin. In a typical case, one video cycle may be repeated throughout the entire operational day.

After management center 10 allocates a video cycle, they may be uploaded to an end point at a predetermined time. For example, management center 10 may upload new video cycles to end points 14 and 15 after each business day or every hour.

Management center 10 further allows easy and convenient planning of advertisement campaigns in the network. Management center 10 enables clients 12 to create campaigns, upload video spots, view billing information, pay for video spots, view uploaded video spots, view current video spot campaigns, and generate statistical information.

Management center 10 may include a backend server 11 for storing end point data information and a frontend client interface 13 for exposing the capabilities of the present disclosure. Backend server 11 stores end point and client data. Further, backend server 11 manages client requests and information. The end point data includes a list of end point locations, availability, statistics, and cost. The client data includes client profiles, campaigns, video spots, and billing information.

The frontend interface 13 allows clients to upload video spots, create campaigns, view billing information, and view campaign information. The client may create campaigns based on impact (number of video spots to be played or viewership desired), cost, location, or product. In this spirit, the campaign allows clients to search end point locations based on these criteria. Other criteria known to those with ordinary skill in the art may also be used. Further, the client may view and generate statistical data based on these criteria. In one embodiment, the client may see how many video spots have been played for a particular day. In another embodiment, the client may view the impact of each end point location in the form of a pie-chart. These embodiments represent only a few exemplary embodiments for generating statistical data using the functionality provided by the management center of the present disclosure.

An end point includes a display, a network connection device, and a computer-readable medium encoded with management center end point software (MCES). In some embodiments, the display is an outdoor screen (e.g., an LED screen) or an indoor screen (e.g., LCD, plasma, or any other screen that may support video playback). The network connection may be a WiFi router with a connection to the Internet, and the storage medium may be a Linux enabled PC having MCES.

The network also opens communication channels for viewers of video spots to report feedback to the system. Viewers can vote for the best video spot of the day/place. Viewers can use the network connection to browse web sites. Viewers can download additional information about advertised products. Moreover, advertising to Bluetooth-enabled mobile phones (and other devices) at end point locations may be employed through the network.

Each end point has a unique identifier, and may connect periodically to the management center. In one embodiment, end points connect to the management center during the night, operating relatively autonomously during operational hours. When an end point connects to the management center, it downloads any video cycles and their associated video spots that are to be played.

Other applications of the network end point may also be realized. For example, each connection through the network connection deployed at the end point may begin with a “welcome webpage.” Targeted advertising for companies may be deployed on this page. An end point may optionally include a camera. The camera enables clients to view their video spots on end points and observe viewership. Further, a camera deployed at an end point assures clients that their video spots are being played. A WiFi router (sometimes also equipped with a Bluetooth device or other communications channel) as part of the end point system further enables viewer feedback. Viewers may voice their responses and reactions to different video spots or they may send their opinion to statistical questions included in the video cycle. Users may upload their opinions through mobile phones, laptops, or other communications devices capable of sending information. The opinions may be sent through the WiFi communication provided at the end point or other communications technologies.

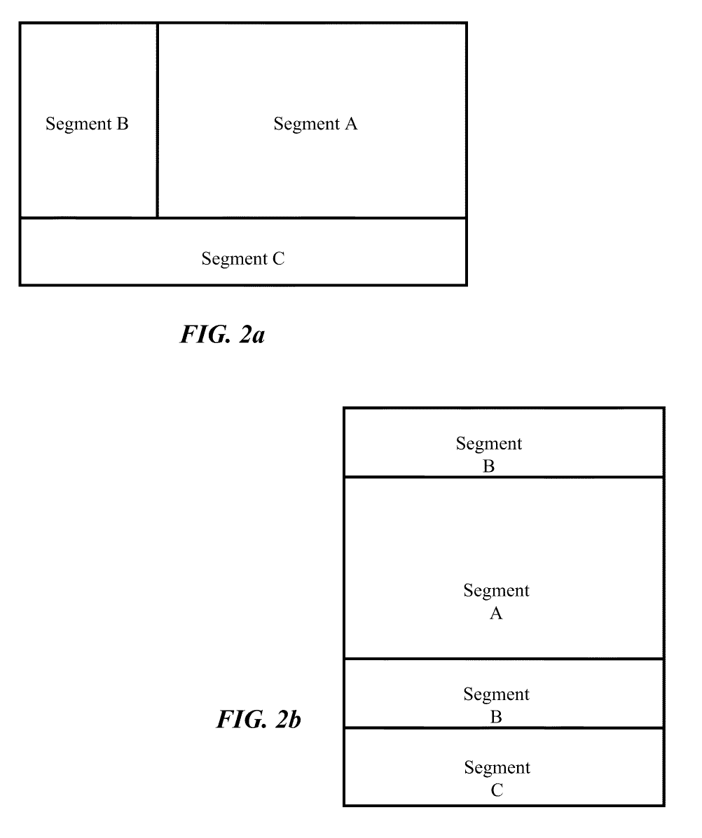

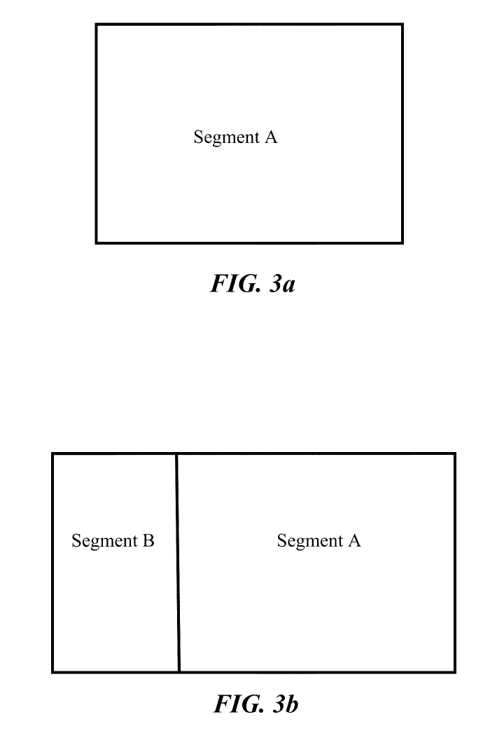

FIGS. 2a, 2b, 3a, and 3b provide four exemplary embodiments of possible end point (indoor or outdoor) displays. Segments A, B, and C broadcast video spots, static or relatively static information, and crawling text, respectively. In one embodiment, segment B may broadcast the date and time or weather information. In another embodiment, segment C may broadcast regional, national, or sports news. Other display configurations may be known to those with ordinary skill in the art. In some embodiments, certain of the information to be displayed may be downloaded from sources other than the management center. As shown in FIG. 2b, multiple embodiments of a single type of segment may be present within a single display. Information uploaded through the network may update segments B and C as needed. In one embodiment, this may occur every five minutes.

End points connecting to management center 10 may be connected to a wide area network (WAN) such as the Internet. In one embodiment, they may be connected through routers that enable WiFi connections at the end point locations. In this spirit, end points may be located in different cities, states, or countries. Further, end points may be either indoor or outdoor end points. For example, an indoor end point may be located in a restaurant, café, pharmacy, bus station, airport, or any other location with potential viewers.

The following discussion provides one exemplary purpose of the present disclosure. Referring back to FIG. 1, a local client 12 uploads an advertisement for a used car to management center 10. After processing, management center 10 uploads the advertisement to an indoor end point 14 located at a bus station. Thus, in one embodiment, the present disclosure provides access to targeted advertising resources for small and large clients.

Further, in another embodiment, a client 12 may upload a birthday video to management center 10. After processing, management center 10 uploads the birthday video to the restaurant where the birthday party is taking place.

End points may have different operational hours. For example, a particular indoor end point 14 may display video cycles only during business hours. Further, to support large scale distribution of end points, a business owner may lease an end point display in return for advertising permission at the end point. After the leasing period, ownership of the end point display may be transferred. In another embodiment, end point displays may be franchised and the operational owner may pay fees in return for access to management center distribution and management capabilities.

A video spot comprises an uploaded video, picture, flash animation, or media of any other supported format. A client may upload video spots or create a campaign of a plurality of video spots at desired end points through management center 10. Management center 10 provides end point selection criteria including location and viewership size. For example, a client may wish to purchase end point time throughout a certain country. In another example, a client selects advertising only at one desired location. Other criteria for selecting advertising time (e.g., cost, available locations) may also be employed.

Management center 10 may screen each video spot to ensure that it complies with the laws of the appropriate country. Additionally, management center 10 may also screen each video spot according to a stricter code of ethics defined by management center 10. Local management centers may also be used to realize this screening function.

Management center 10 functions as a server for end points 14 and 15. Each end point includes MCES to facilitate processing of video cycles. MCES provides each end point with a unique end point number enabling video spot location and allocation requests and targeted data. MCES further enables the management center to recognize each end point and process end point requests.

Further, MCES may mitigate the need for a constant connection to management center 10. In one embodiment, end points may connect to backend server 11 of management center 10 after operational hours to request video cycle data. Other updates, such as crawling text and weather/time information may be gathered at intervals throughout operational hours or only after operational hours. They may also be gathered from websites not directly connected to management center 10. MCES may further provide video storage functionality, a flash player, a video player, and video cycle request time.

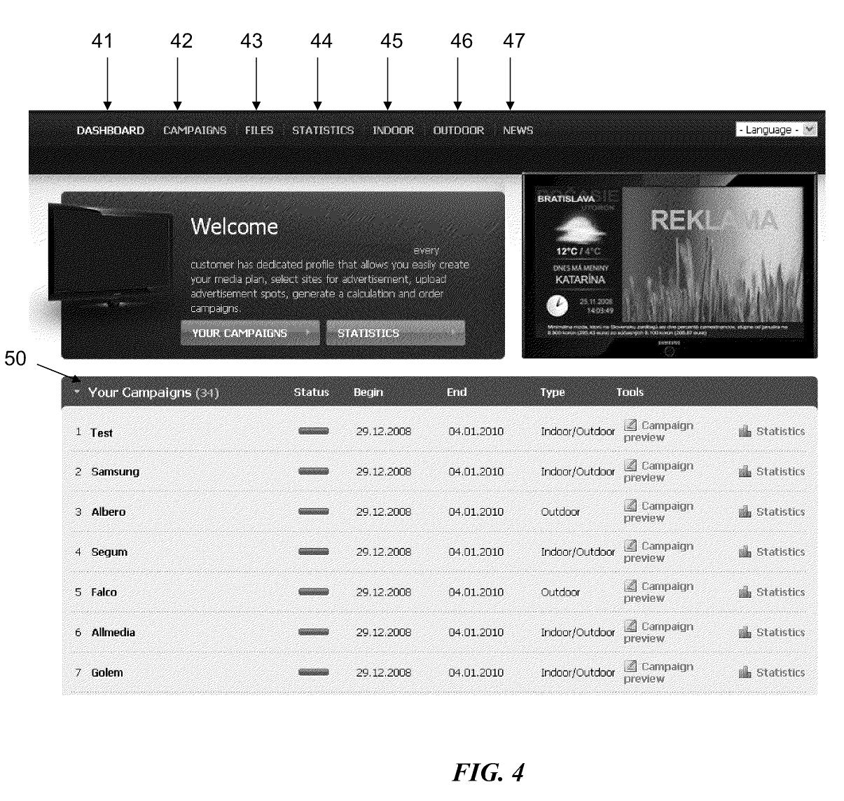

The following discussion provides an exemplary client campaign creation process. The interface presents only one of an infinite possibility of possible interfaces for exposing the capabilities of the present disclosure. In this embodiment, a client first logs in to the client side of the management center. As shown in FIG. 4, the client may then choose from seven different tabs:
1. Dashboard 41
2. Campaigns 42
3. Files 43
4. Statistics 44
5. Indoor 45
6. Outdoor 46
7. News 47

The pages associated with these tabs will be discussed in more detail below.

FIG. 4 shows the Dashboard page associated with Dashboard tab 41, which contains a list 50 of the client's campaigns. This page allows the client to get previews and basic statistics on the campaigns he has created. The Dashboard page is a quick overview, with more detailed information available under Campaigns tab 42 and Statistics tab 44.

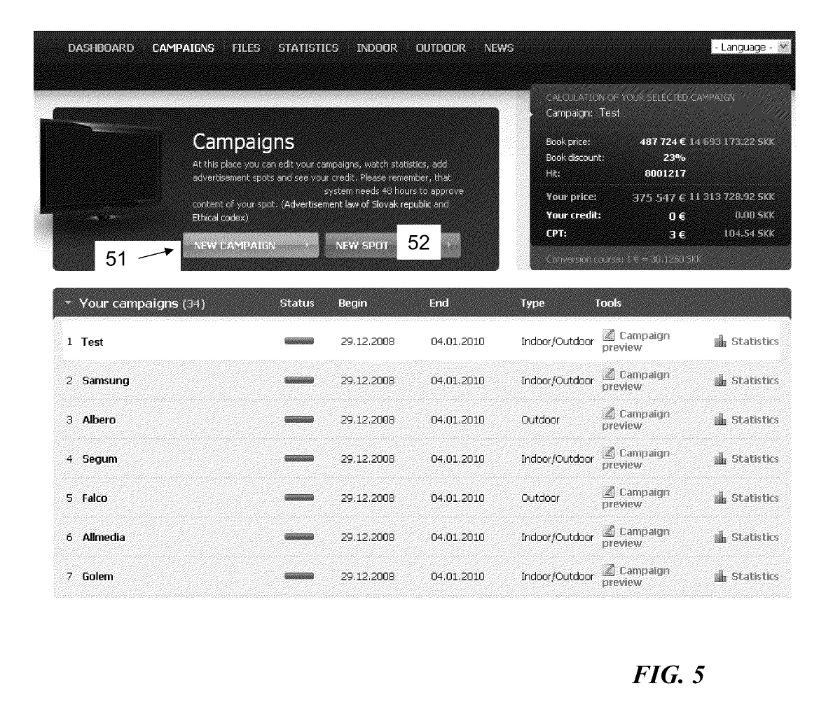

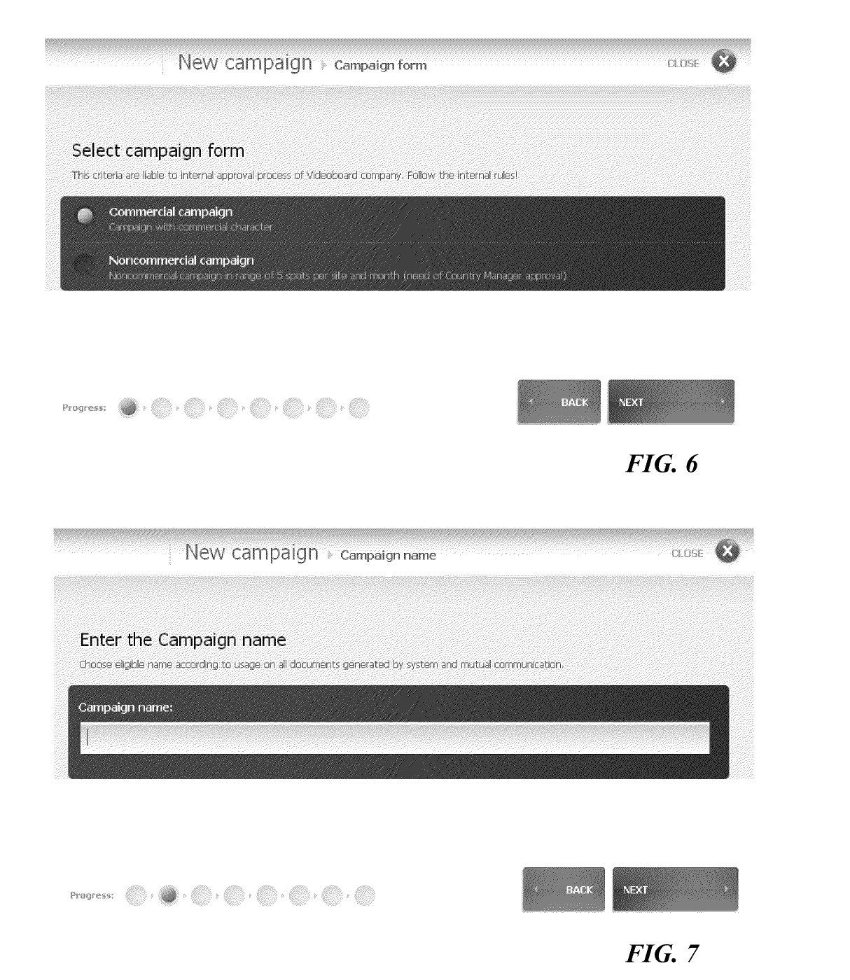

FIG. 5 shows the Campaigns page associated with Campaigns tab 42. This page allows a client to create or upload a new video spot using New Spot button 52. This page also allows a client to create a whole new campaign, using New Campaign button 51. FIGS. 6-13 illustrate the process of creating a new campaign. After clicking on New Campaign button 51, a client is presented with the display shown in FIG. 6.

FIG. 6 illustrates one version of a new campaign page. The new campaign page provides two options for planning a new media campaign. The present disclosure presents a method to create either a commercial campaign or a noncommercial campaign. Certain options may or may not be presented based on client status.

Once the client chooses the campaign planning method, the client enters the name of the new campaign as shown in FIG. 7.

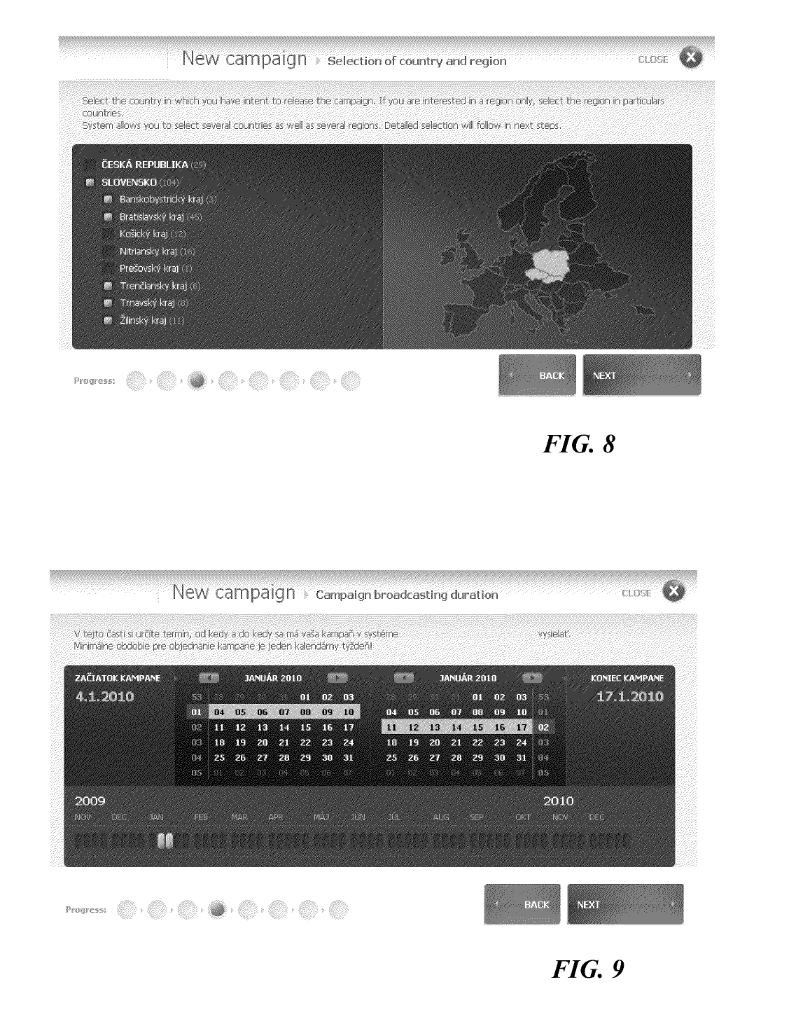

FIG. 8 illustrates an embodiment for choosing the location (end point/end points) of the campaign. A client can choose based on country, region, city (not shown), or individual places (not shown). Other method for locating an end point may also be used such as searching for an end point within a country, city, or street. Another embodiment could include searching by location type (ex. restaurant, café, or outdoor, indoor, etc.).

After the client selects the campaign location, he may select the campaign time. FIG. 9 shows an embodiment of an interface for choosing the campaign time having calendars for start and end times. The client may select the desired beginning and ending campaign dates and times.

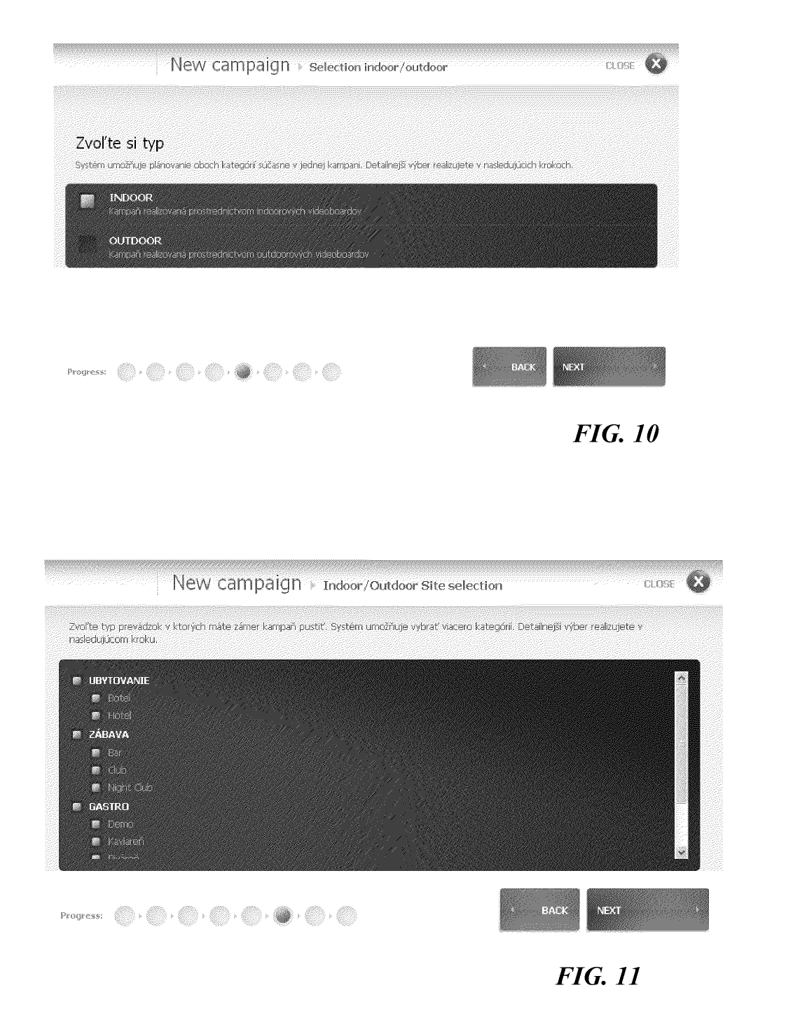

In FIG. 10, the client may choose which broad categories of end points are desired: indoor, outdoor, or both. Then in FIG. 11, the client may choose with more granularity the types of end point locations desired. As shown, in one embodiment, options might include accommodations (UBYTOVANIE), entertainment venues (ZÁBAVA), or restaurants (GASTRO).

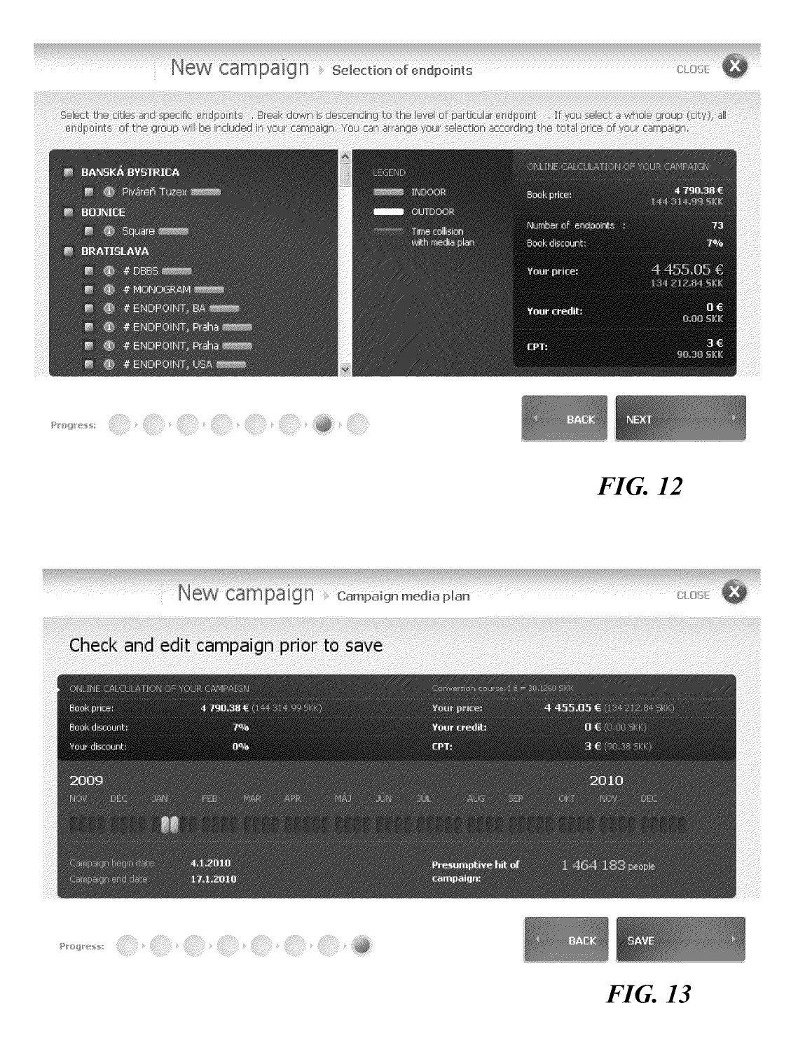

As shown in FIG. 12, the system may then present the client with a list of all end points satisfying the criteria previously entered. The client may then select the individual end points desired for the campaign. The screen shown in FIG. 12 may concurrently show the client the cost of the campaign as configured, so that the client may tailor his choice of end points for a desired price point.

FIG. 13 presents the client with attributes of the campaign (cost, time, and predicted impact) that the client selected. The client may then save the campaign or change attributes of the plan.

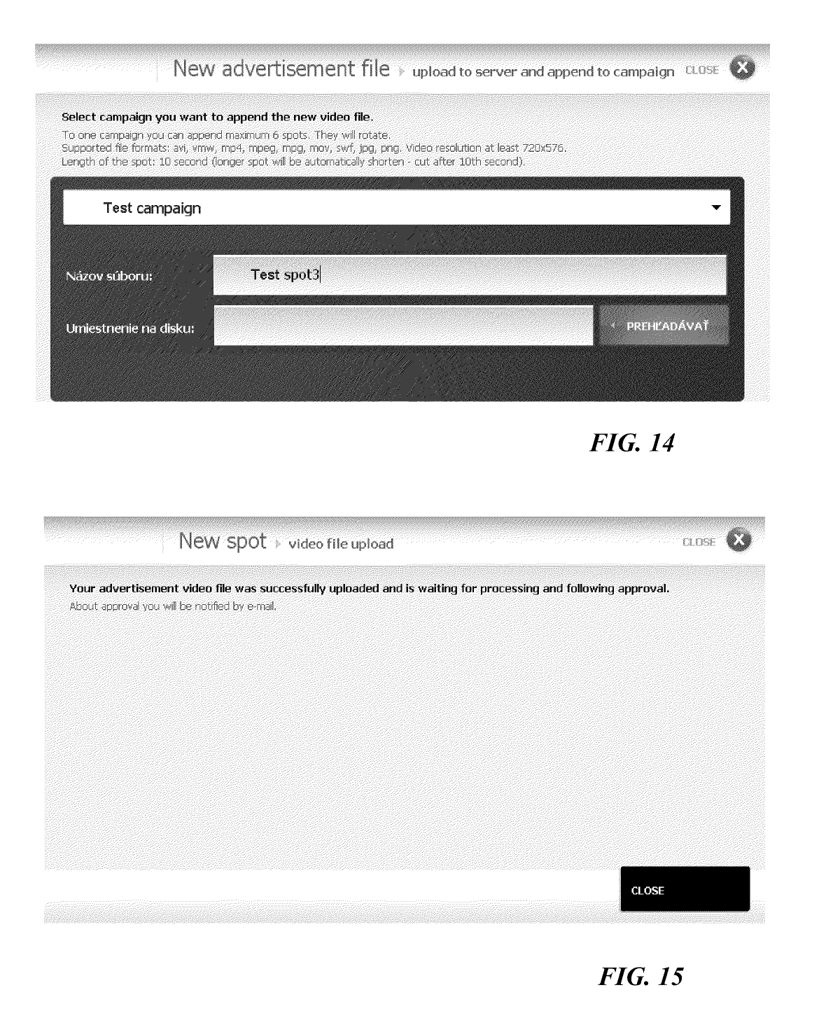

After selecting defining the campaign parameters, the client may upload video spots, as shown in FIGS. 14-15. A client may upload as many video spots per campaign as the campaign parameters allow.

In an exemplary embodiment, six video spots may be displayed in one campaign. For example, suppose the client chooses to upload their campaign in an almost-full video cycle (e.g., the client books only one video spot/cycle); this means there will be room for only twelve different video spots displayed per hour (30 total video spots/cycle*10 sec/video spot=5 min/cycle=12 cycles/hour). This means each of the 6 chosen video spots are displayed 2 times per hour as part of that campaign. If the video cycle is less full, the video spots may be displayed more times per hour.

To create a new video spot, the client clicks on New Spot button 52 from the Campaigns page shown in FIG. 5. This brings up the “New advertisement file” screen shown in FIG. 14. From here, the client may choose which campaign the spot is for, the name of the spot, and location of the file to upload to the management center.

As shown in FIG. 15, the client may then be notified that the file containing the video spot has been uploaded, and a confirmation email may be sent.

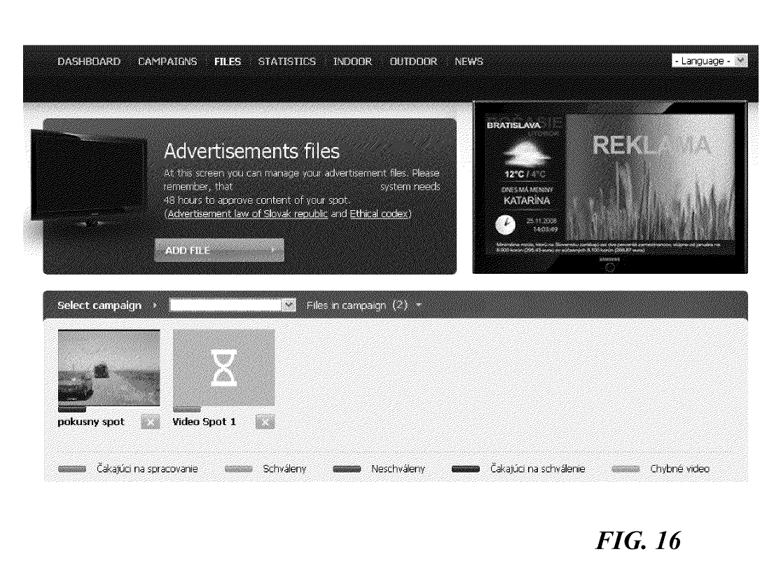

FIG. 16 shows the Files page associated with Files tab 43. From this page, the client may see all of the video spots he has uploaded to the system. The client may select a certain campaign, and this page will show information about all the spot files associated with that campaign. In one embodiment, the page may offer color-coded information about all the different files to indicate the status of the file (e.g., approved, not approved, awaiting approval, or error). The Files page also may offer an “Add File” button, which may present the user with the same interface shown in FIG. 14.

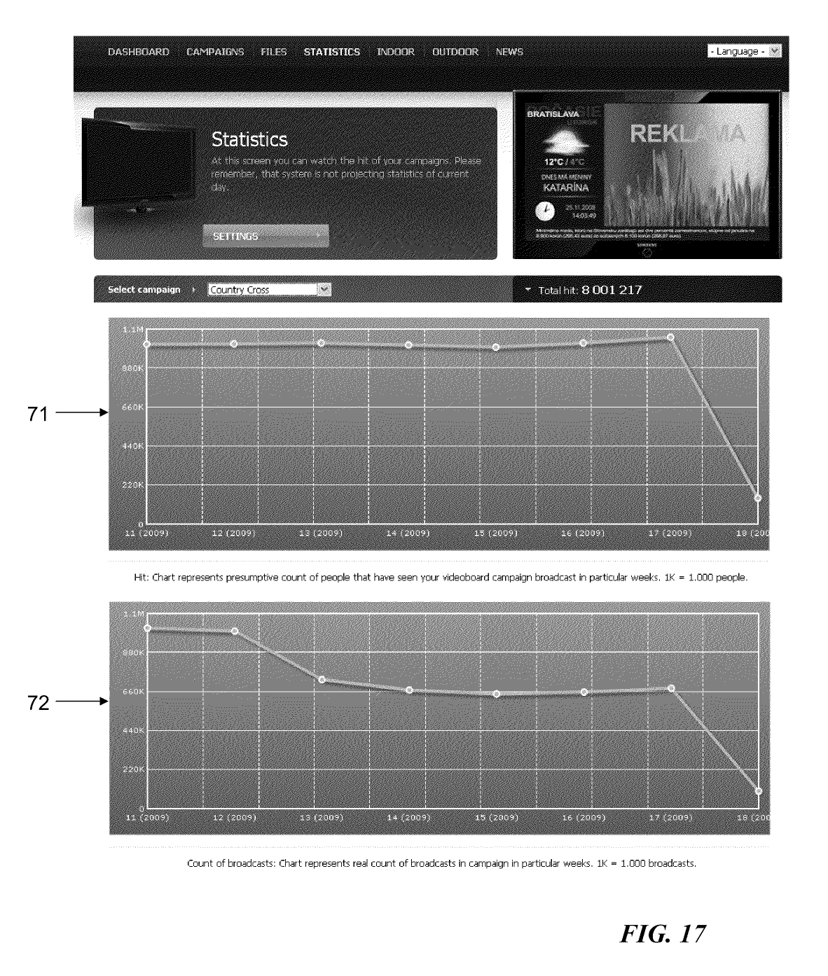

FIG. 17 shows the Statistics page associated with Statistics tab 44. Chart 71 shows a projected estimate of how many people will see a given campaign over time. Chart 72 shows the actual number of times the campaign has been played on all selected end points. Various other types of statistics may be presented without departing from the spirit of the present disclosure, as one of ordinary skill will recognize.

The Indoor and Outdoor pages associated with Indoor tab 45 and Outdoor tab 46, respectively, serve essentially the same function, so only the Indoor page will be shown and discussed in detail. One of ordinary skill will recognize that the analogous function for outdoor end points will be served by the Outdoor page (not shown in the FIGUREs).

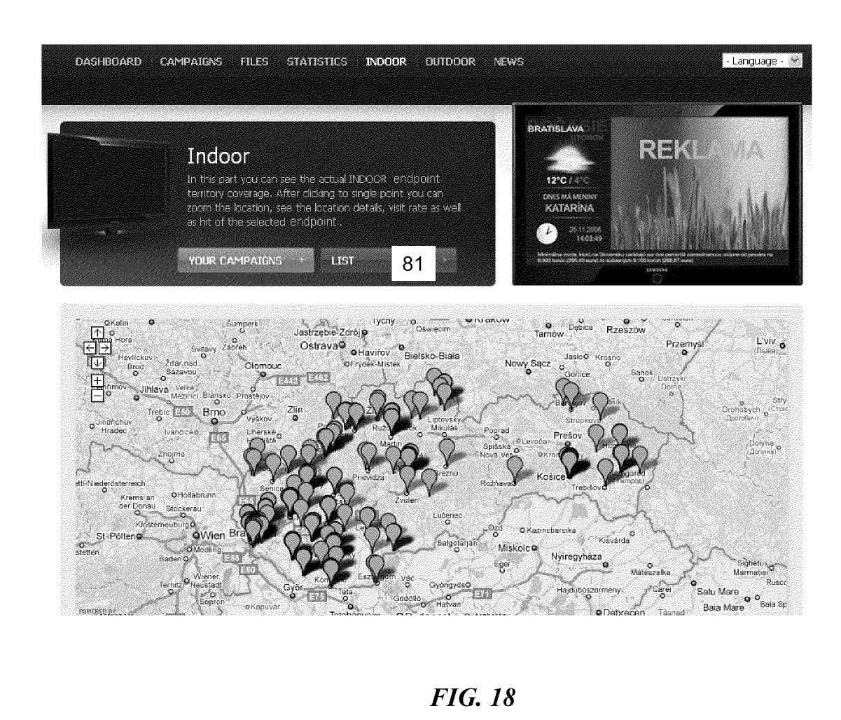

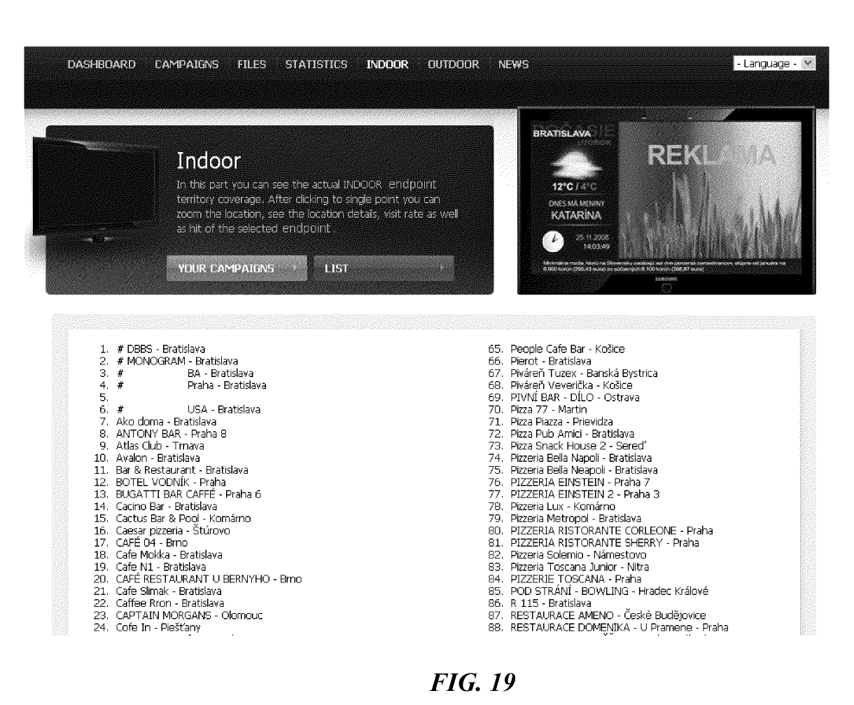

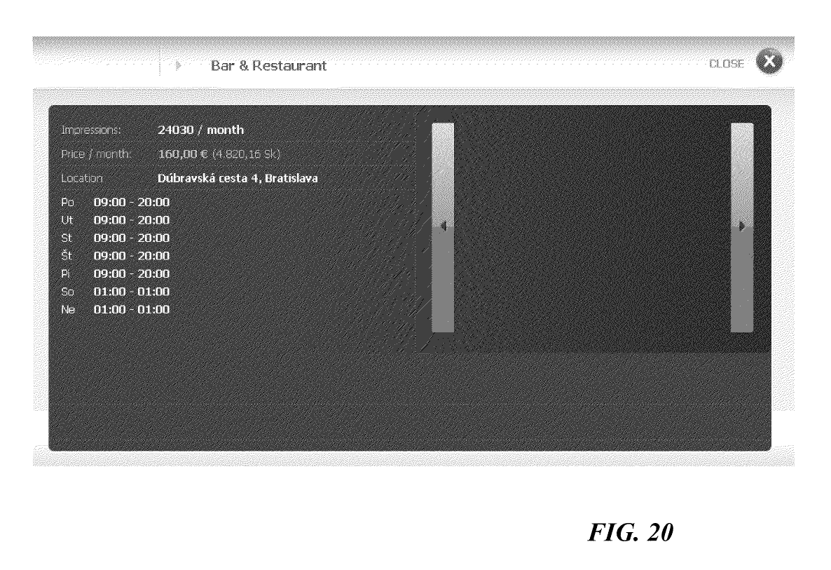

FIG. 18 shows Indoor page, which presents a map of all available indoor end points. A client may click on List button 81 to be taken to the list view page shown in FIG. 19. The list view may present a list of end points and their locations. By selecting an end point, a client may be taken to the screen shown in FIG. 20, from which more detail about individual end points (e.g., location, operating hours, likely number of visitors, cost, etc.) is available.

Finally, News tab 47 may take the client to a page (not shown) in which news can be viewed. The news on this page may be tailored to the particular client, available to all clients, or a mixture of the two.

Various payment methods known in the art may be used to purchase campaign time. In one embodiment, a credit limit on the client account limits the campaign time a user may purchase. A new user may only purchase campaign time less than the credit amount. Trusted clients may exceed this amount by a certain percentage and pay at a later date. In another method, clients an online auction may take place ensuring that the highest bidder always gets their video spot played at the desired location and time.

The present disclosure provides a method and system for distribution and management of video spots. Clients may upload video spots and select end points for distribution. Clients may further choose criteria such as location, cost, impact, and dates for creation of video spot campaigns. Management center provides management and distribution capabilities of uploaded video spots. Management center distributes video spots to end points based on client selected criterion. Further, management center provides access to vital video spot and campaign management resources including statistical information, price, date, and live web feed of end point viewership. MCES allows for efficient communication between end points and management center.

The method and system of the present disclosure enable enhanced video distribution and management by centralizing the management process. The management center allows client access to end points throughout the network and enables targeted advertising for small and large clients.

Although the presently disclosed subject matter has been described in detail herein with reference to the illustrative embodiments, it should be understood that the description is by way of example only and is not to be construed in a limiting sense. It is to be further understood, therefore, that numerous changes in the details of the embodiments of this teaching and additional embodiments of this subject matter will be apparent to, and may be made by, persons of ordinary skill in the art having reference to this description. It is contemplated that all such changes and additional embodiments are within the spirit and true scope of the present teaching as defined by the claims.

The foregoing description of the preferred embodiments is provided to enable a person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A content distribution system, comprising:
a management center for accepting content from a client; and
a plurality of end points capable of displaying said content, wherein
each end point of said plurality of end points comprises a display, a computer, and a network connection device for communicating with said management center;
said management center allows said client to select at least one end point from said plurality of end points to display said content; and
said management center allows said client to determine when said at least one end point will display said content.

2. The content distribution system of claim 1, wherein
said management center is accessible by said client according to a web page interface.

3. The content distribution system of claim 1, wherein
said management center is operable to combine said content into at least one cycle; and wherein
said at least one end point is operable to display said at least one cycle a plurality of times.

4. The content distribution system of claim 1, wherein
said management center is operable to send statistical data to said client.

5. The content distribution system of claim 1, wherein
said at least one end point is operable to simultaneously display video and relatively static content.

6. The content distribution system of claim 1, wherein
said at least one end point is operable to simultaneously display video, relatively static content, and crawling text.

7. The content distribution system of claim 1, wherein said at least one end point further comprises
a camera operable to record a video of an area adjacent to said end point.

8. The content distribution system of claim 7, wherein
said at least one end point transmits said video to said management center.

9. A method for distributing content, said method comprising:
receiving content at a management center from a client;
processing said content into at least one cycle;
transmitting said at least one cycle to at least one end point, said end point comprising a display;
displaying said at least one cycle on said display.

10. The method of claim 9, wherein said step of receiving said content from said client comprises receiving via a web page interface.

11. The method of claim 9, wherein said step of displaying said at least one cycle comprises displaying said at least one cycle a plurality of times.

12. The method of claim 9, further comprising the step of transmitting statistical data from said management center to said client.

13. The method of claim 9, wherein said at least one cycle comprises simultaneously displayed video and relatively static content.

14. The method of claim 13, wherein said at least one cycle further comprises simultaneously displayed crawling text.

15. The method of claim 9, further comprising the step of recording a video of an area adjacent to said end point.

16. The method of claim 15, further comprising the step of transmitting said video to said management center.

17. A tangible computer-readable medium encoded with instructions for content distribution, wherein said instructions comprise:
instructions for displaying a web interface to a client;
instructions for receiving content from said client;
instructions for allowing said client to choose at least one end point from a plurality of end points, based on at least one client criterion;
instructions for processing said content into at least one cycle; and
instructions for transmitting said at least one cycle to said at least one end point.

18. The tangible computer-readable medium of claim 17, further comprising:
instructions for recording statistical data on said at least one cycle; and
instructions for transmitting said statistical data to said client.

19. The tangible computer-readable medium of claim 17, wherein
said at least one cycle comprises simultaneously displayed video and relatively static content.

20. The tangible computer-readable medium of claim 19, wherein
said at least one cycle further comprises simultaneously displayed crawling text.
